(19) United States
(12) Patent Application Publication
(10) Pub. No.: US 2023/0287186 A1
(43) Pub. Date: Sep. 14, 2023

(54) PLASTIC RESIN MODIFIER COMPOSITIONS AND METHODS FOR PREPARING THERMOPLASTIC MATERIALS AND ARTICLES USING THE SAME

(71) Applicant: VICTAMAX LIMITED, Hong Kong (CN)

(72) Inventors: Yiu Ting Richard LAU, Hong Kong (CN); Cheuk Hung YIP, Hong Kong (CN); Zhao Jia Robert YAN, Hong Kong (CN)

(21) Appl. No.: 18/040,127

(22) PCT Filed: Sep. 15, 2021
(86) PCT No.: PCT/AU2021/051065

§ 371 Date: Jan. 31, 2023

(30) Foreign Application Priority Data
Sep. 15, 2020 (AU) 2020903294

(51) Int. Cl. C08J 3/22; B29C 48/00; B29C 48/40; B29C 45/00; C08F 210/06; C08J 3/12; C08K 5/00; C08L 23/06

(52) U.S. Cl. CPC C08J 3/22; B29C 45/0001; B29C 45/0055; B29C 48/022; B29C 48/40; C08F 210/06; C08J 3/12; C08K 5/0058; C08L 23/06; B29K 2023/12; C08J 2323/06; C08L 2310/00

(57) ABSTRACT

The present disclosure relates to thermoplastic resin modifier compositions, methods for converting the compositions into functional resins, and to plastic articles prepared from the resins.

### FIELD OF THE DISCLOSURE

The present disclosure relates to thermoplastic resin modifier compositions, methods for converting the compositions into functional resins, and to plastic articles prepared from the resins.

### BACKGROUND OF THE DISCLOSURE

Any discussion of the prior art throughout this specification should in no way be considered as an admission that such prior art is widely known or forms part of the common general knowledge in the field.

Existing techniques for imparting antifouling, antimicrobial and anti-biofilm properties to inanimate substrates to reduce adhesion and inhibit growth/colonisation of microorganisms fall into the following six general categories. (i) release killing, (ii) contact killing, (iii) controlled depletion coatings, (iv) self-polishing coatings, (v) foul release coatings and, (vi) a combination of the above approaches.

Techniques such as release killing involve immobilising antimicrobial compounds to a surface which are released over time to provide an antimicrobial effect. Over time such surfaces may lose their antimicrobial properties as the immobilised antimicrobial compounds are depleted. The immobilised antimicrobial compounds may also be deleterious to the environment into which they are released.

Alternative techniques involve minimising microbial adherence by creating biomimetic surface topographies. However, the fabrication process is complex and costly, and therefore not suited to volume production in low-end industries. Further techniques make use of robust encapsulation, stimuli-responsive materials, solid support, and even bacteria themselves to trigger or sustain release of biocides from carrier matrices. Whilst antimicrobial performance is potent, these techniques rely on release killing and as a result their effectiveness decreases over time. Additional techniques rely on add-on devices or external energy fields to impart fouling resistance to the substrate surface.

More recently, scalable coating and biocide-free techniques have been developed for producing inherently germ-repellent plastic formulations without affecting the physical properties of the base materials after modification. However, the fabrication methods involve the use of several non-ionic surfactants composed of short-chain aliphatic ethers, heterofunctional oligo(alkylene glycols) and polysorbates, which are susceptible to oxidative degradation and enhanced formation of peroxides when combined with a thermal free-radical polymerisation initiator in a single pot.

The present disclosure seeks to overcome or ameliorate at least some of the disadvantages described above.

### SUMMARY OF THE DISCLOSURE

In a first aspect there is provided a thermoplastic resin modifier composition comprising, consisting of, or consisting essentially of:
(i) a vinyl monomer;
(ii) a co-polymerisable anhydride;
(iii) a thermal free-radical polymerisation initiator; and
(iv) a thermoplastic resin.

The vinyl monomer may be present in the composition in an amount between about 0.5% (w/w) and about 4% (w/w).

The co-polymerisable anhydride may be present in the composition in an amount between about 0.5% (w/w) and about 4% (w/w).

The thermoplastic resin may be present in the composition in an amount between about 90% (w/w) and about 98% (w/w).

The thermal free-radical polymerisation initiator may be present in the composition in an amount between about 0.05% (w/w) and about 4% (w/w).

The vinyl monomer may comprise one or more moieties having antimicrobial, antiviral or antifouling properties.

The one or more moieties having antimicrobial, antiviral or antifouling properties may be hydroxy, amino or carboxyl groups.

The one or more moieties having antimicrobial, antiviral or antifouling properties may be: a natural peptide, a N-substituted amide, a squalene, a tannin, a saponin, a flavonoid, an alkaloid, a steroid, a lactone, a lectin, a lactam, a pilicide, a curlicide, an alkyl glycoside, an aminoglycoside, a glycopolymer, a glycolipid, a sugar ester, a quaternary ammonium compound, a terpene, a terpenoid, a fatty acid, a fatty acid ester, an alkyl amine, an alkyl amine oxide, an alcohol alkoxylate, a nitroxide, a halamine, a diaryl ether, a xanthone, a quinone, a coumarin, a polyacetylene, a guanidine, a halogen, a phospho derivative, a sulfo derivative, a phenolic derivative, a benzoic derivative, an organometallic, a pyridinium derivative, a piperazine derivative, a pyrrolidone derivative, an aniline derivative, a biguanide and related compounds, an oxime and related compounds, an isothiazolinone and related compounds, an indole derivative, a heteroazole derivative, a heteroazoline derivative, a hydrazide-hydrazone derivative, a pyran and related compounds, a furan and related compounds, a macrolide, a tetracycline, an oxazolidinone, a quinolone, an amidoxime, an amidoamine, and a polypropylene imine.

The vinyl monomer may be a short-chain alkene, a styrene, an alkyl acrylate, an alkyl acrylate ester, a vinyl acetate, a vinyl alcohol, a vinyl phenol, a vinyl alkyl ether, a vinyl halide, a vinylacetic acid, an acrylonitrile, an acrylamide, a vinyl silane, a vinyl sulfide, a vinyl sulfone, a vinyl sulfoxide, a vinylethylene carbonate, a vinylpyrrolidone, a vinylcarbazole, a vinyl norbonene, an unsaturated fatty acid, or an unsaturated fatty acid ester.

In one embodiment, the vinyl monomer is styrene, α-methylstyrene, vinyl naphthalene, isobutylene, vinyl norbornene, butyl vinyl ether or 2-chloroethyl vinyl ether.

The thermoplastic resin modifier composition may comprise a plurality of vinyl monomers.

In some embodiments the plurality of vinyl monomers may be selected from vinyl acetate, acrylamide, N-isopropylacrylamide, N-vinyl pyrrolidone, N-methylolacrylamide, acrylamidoglycolic acid, acrylonitrile, methacrylic acid, methyl methacrylate, 2-hydroxyethyl methacrylate, 2-aminoethyl methacrylate, 2-(dimethylamino)ethyl methacrylate, 3-methacryloxypropyltrimethoxysilane, 2-carboxyethyl acrylate, 2-azepane ethyl methacrylate, glycidyl methacrylate, 2-vinylpyridine, 4-tert-butoxystyrene and 4-vinylcatechol acetonide.

The co-polymerisable anhydride may be an organic acid anhydride, such as for example maleic anhydride or tetrahydrophthalic anhydride.

The thermal free-radical polymerisation initiator may be a peroxide or an azo compound.

In one embodiment the free-radical polymerisation initiator may be a mixture of benzoyl peroxide and dicumyl peroxide.

The benzoyl peroxide and dicumyl peroxide may be present in a molar ratio between about 20:80 and about 80:20.

The thermoplastic resin may be a medium-to-high-flow homopolyolefin, a multiblock copolymer a random copolymer, or a blend thereof.

The thermoplastic resin may be an addition polymer, a polyolefin elastomer, a thermoplastic olefin or a rubber.

The thermoplastic resin may be PE, PP, PB, COC, PMP, PVB, PAN, NBR, EPR, PI, SEBS, SEPS, SBS, SIS, MBS, ABS, EBA, EVA, EVOH, EAA, EMA, EPDM, ETFE, ECTFE, EVCL, poly(ethylene-co-1-octene), poly(ethylene-co-1-hexene), neoprene, an olefin metathesis product, or any combination thereof.

The thermoplastic resin modifier composition may further comprise an organic solvent.

The thermoplastic resin modifier composition may further comprise a deodorant.

The thermoplastic resin modifier composition may be free, or substantially free of surfactants, such as for example non-ionic surfactants.

In a second aspect there is provided a method for preparing a modified thermoplastic resin composition, the method comprising, consisting of, or consisting essentially of: combining:
(i) a vinyl monomer;
(ii) a co-polymerisable anhydride;
(iii) a thermal free-radical polymerisation initiator; and
(iv) a thermoplastic resin, so as to provide a mixture,
and subjecting the mixture to melt processing or solvent-assisted solid-phase polymerisation.

The vinyl monomer may be present in the mixture in an amount between about 0.5% (w/w) and about 4% (w/w).

The co-polymerisable anhydride may be present in the mixture in an amount between about 0.5% (w/w) and about 4% (w/w).

The thermoplastic resin may be present in the mixture in an amount between about 90 % (w/w) and about 98% (w/w).

The thermal free-radical polymerisation initiator may be present in the mixture in an amount between about 0.05% (w/w) and about 4% (w/w).

Melt processing may comprise extrusion, molding, blown film, spinning, drawing, pressing, kneading, roll milling or thermoforming. In one embodiment, melt processing comprises extrusion.

Each of the vinyl monomer, co-polymerisable anhydride, thermal free-radical polymerisation initiator and thermoplastic resin may be as defined in the first aspect.

The mixture may further comprise an organic solvent.

The mixture may further comprise a deodorant.

The mixture may be free, or substantially free of surfactants, such as for example non-ionic surfactants.

The mixture may contain only components (i) to (iv).

The modified thermoplastic resin composition may be subjected to a surface treatment.

The surface treatment may be a treatment that imparts stain, oil and/or water repellent properties to the modified thermoplastic resin composition.

In a third aspect there is provided a modified thermoplastic resin composition, whenever prepared by the method of the second aspect.

In a fourth aspect there is provided a method for preparing a functional resin composition comprising combining the modified thermoplastic resin composition of the third aspect with one or more additives to form a mixture, and subjecting the mixture to melt processing.

The one or more additives may be present in the composition an amount between about 90% (w/w) and about 99% (w/w).

The one or more additives may include a compound or compounds having antimicrobial, antiviral or antifouling properties.

The compound or compounds having antimicrobial, antiviral or antifouling properties may be present in the composition in an amount between about 0.05% (w/w) and about 2% (w/w).

The compound or compounds having antimicrobial, antiviral or antifouling properties may be hydrophilic compounds.

The compound or compounds having antimicrobial, antiviral or antifouling properties may be amphiphilic compounds.

The compound or compounds having antimicrobial, antiviral or antifouling properties may be one or more alcohol ethoxylates.

The amphiphilic compounds may have a HLB value of greater than about 7.

The amphiphilic compounds may have a HLB value between about 7 and about 20.

The one or more additives may include a core material resin.

The core material resin may be present in the composition in an amount between about 90% (w/w) and about 99% (w/w).

The one or more additives may include an antioxidant.

Melt processing may comprise extrusion, molding, blown film, spinning, drawing, pressing, kneading, roll milling or thermoforming.

Melt processing may comprise extrusion.

In a fifth aspect there is provided a functional resin composition, whenever prepared by the method of the fourth aspect.

In a sixth aspect there is provided a method for producing a plastic article comprising shaping the functional resin composition of the fifth aspect.

Shaping may be achieved by molding.

The molding may be injection molding, rotational molding, blow molding or compression molding.

In an embodiment of the sixth aspect there is provided a method for preparing a plastic article comprising:
(i) combining:
   (a) a modified thermoplastic resin composition;
   (b) a core material resin; and
   (c) a compound selected from: an alcohol ethoxylate, an alkylene oxide and a polyethylene glycol, to form a mixture;
(ii) subjecting the mixture to melt processing or solvent-assisted solid-phase polymerisation to provide a functional resin composition; and
(iii) shaping the functional resin composition to provide the plastic article, and wherein the modified thermoplastic resin composition is prepared by mixing:
   (d) a vinyl monomer;
   (e) a co-polymerisable anhydride;
   (f) a thermal free-radical polymerisation initiator; and
   (g) a thermoplastic resin to form a mixture, and
(iv) subjecting the mixture to melt processing or solvent-assisted solid-phase polymerisation.

In the mixture comprising (a), (b) and (c), component (a) may be present in an amount between about 0.5% (w/w) and about 3% (w/w), component (b) may be present in an amount between about 95% (w/w) and about 99% (w/w), and component (c) may be present in an amount between about 0.05% (w/w) and about 3% (w/w).

In the mixture comprising (d), (e), (f) and (g), component (d) may be present in an amount between about 0.5% (w/w) and about 5% (w/w), component (e) may be present in an amount between about 0.5% (w/w) and about 5% (w/w), component (f) may be present in an amount between about 0.05% (w/w) and about 3% (w/w) and component (g) may be present in an amount between about 90% (w/w) and about 99% (w/w).

The mixture comprising (d), (e), (f) and (g) may contain only components (d), (e), (f) and (g).

The core material resin may be a polypropylene.

The polypropylene may be polypropylene random copolymer.

In step (c), the compound may be an alcohol ethoxylate.

The alcohol ethoxylate may have the following general formula: RO(CH₂CH₂O)ₙH, wherein R is C₁₂-C₁₄ alkyl and n=3 to 23.

The alcohol ethoxylate may have the following general formula: RO(CH₂CH₂O)ₙH, wherein R is C₁₂-C₁₄ alkyl and n = 3 to 9.

The alcohol ethoxylate may have a HLB 10 value between about 10 and 11.

Melt processing in steps (ii) and (iv) may comprise extrusion.

The mixture in step (i) may further comprises an antioxidant.

The vinyl monomer may be styrene.

The co-polymerisable anhydride may be maleic anhydride.

The thermal free-radical polymerisation initiator may be dicumyl peroxide.

The thermoplastic resin may be a polypropylene.

The mixture of (d), (e), (f) and (g) may be free, or substantially free of surfactants.

Shaping in step (iii) may be performed by molding.

The molding may be injection molding.

The plastic article may be a protein-repellent plastic article.

The plastic article may be an antimicrobial and/or antiviral article.

In a seventh aspect there is provided a method for producing a plastic article comprising combining the modified thermoplastic resin composition of the third aspect with one or more additives to form a masterbatch, combining the masterbatch with a core material resin to form a mixture, and processing the mixture to form the plastic article.

In an eighth aspect there is provided a method for producing a plastic article comprising combining the modified thermoplastic resin composition of the third aspect with a masterbatch and a core material resin to form a mixture, and processing the mixture to form the plastic article.

The masterbatch may comprise a compound or compounds having antimicrobial, antiviral or antifouling properties.

The compound or compounds having antimicrobial, antiviral or antifouling properties may be hydrophilic compounds.

The compound or compounds having antimicrobial, antiviral or antifouling properties may be amphiphilic compounds.

The amphiphilic compounds may have a HLB value of greater than about 7.

The amphiphilic compounds may have a HLB value between about 7 and about 20.

In an embodiment of the eighth aspect there is provided a method for preparing a plastic article comprising:
(i) combining:
   (a) a modified thermoplastic resin composition;
   (b) a core material resin; and
   (c) a masterbatch comprising an alcohol ethoxylate, an alkylene oxide or a polyethylene glycol, to form a mixture; and
(ii) shaping the mixture to provide the plastic article, wherein the modified thermoplastic resin composition is prepared by mixing:
   (d) a vinyl monomer;
   (e) a co-polymerisable anhydride;
   (f) a thermal free-radical polymerisation initiator; and
   (g) a thermoplastic resin to form a mixture, and
(iii) subjecting the mixture of (d), (e), (f) and (g) to melt processing or solvent-assisted solid-phase polymerisation.

In the mixture comprising (a), (b) and (c), component (a) may be present in an amount between about 5% (w/w) and about 15% (w/w), component (b) may be present in an amount between about 80% (w/w) and about 95% (w/w), and component (c) may be present in an amount between about 1% (w/w) and about 7.5% (w/w).

In the mixture comprising (d), (e), (f) and (g), component (d) may be present in an amount between about 0.5% (w/w) and about 5% (w/w), component (e) may be present in an amount between about 2% (w/w) and about 10% (w/w), component (f) may be present in an amount between about 0.05% (w/w) and about 3% (w/w) and component (g) may be present in an amount between about 90% (w/w) and about 99% (w/w).

The masterbatch may further comprise a core material resin.

The masterbatch may be a masterbatch that was prepared by melt blending the alcohol ethoxylate, alkylene oxide or polyethylene glycol and the core material resin.

The core material resin may be polypropylene.

The polypropylene may be polypropylene random copolymer.

The core material resin may be thermoplastic elastomer.

The masterbatch may comprise an alcohol ethoxylate.

The alcohol ethoxylate may have the following general formula: RO(CH₂CH₂O)ₙH, wherein R is C₁₂-C₁₄ alkyl and n = 3-9.

The alcohol ethoxylate may have the following general formula: RO(CH₂CH₂O)ₙH, wherein R is C₁₂-C₁₄ alkyl and n = 5.

The alcohol ethoxylate may have a HLB value between 10 and 11.

Shaping in step (ii) may be performed by molding.

The molding may be injection molding.

Melt processing in step (iii) may comprise extrusion.

The vinyl monomer may be styrene.

The thermoplastic resin may be a thermoplastic elastomer.

The co-polymerisable anhydride may be maleic anhydride.

The thermal free-radical polymerisation initiator may be dicumyl peroxide.

The mixture of (d), (e), (f) and (g) may be free, or substantially free of surfactants.

The plastic article may be a protein-repellent plastic article.

The plastic article may be an antimicrobial and/or antiviral article.

In a ninth aspect there is provided a plastic article, whenever obtained by the method of any one of the sixth to eighth aspects.

### Definitions

The following are some definitions that may be helpful in understanding the description of the present disclosure. These are intended as general definitions and should in no way limit the scope of the present disclosure to those terms alone, but are put forth for a better understanding of the following description.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

In the context of this specification the term “about” is understood to refer to a range of numbers that a person of skill in the art would consider equivalent to the recited value in the context of achieving the same function or result.

Any numerical range recited herein is intended to include all sub-ranges of the same numerical precision subsumed within the recited range. For example, a range of 1.0 to 5.0 is intended to include all sub-ranges between (and including) the recited minimum value of 1.0 and the recited maximum value of 5.0, that is, having a minimum value equal to or greater than 1.0 and a maximum value equal to or less than 5.0, such as 2.1 to 4.5. Any maximum numerical limitation recited herein is intended to include all lower numerical limitations subsumed therein and any minimum numerical limitation recited herein is intended to include all higher numerical limitations subsumed therein.

The term “substantially free” as used in reference to surfactant content means that surfactants constitute less than about 3% (w/w), or less than about 2% (w/w), or less than about 1% (w/w), or less than about 0.5% (w/w), or less than about 0.1% (w/w), or less than about 0.05% (w/w), or less than about 0.01% (w/w), or less than about 0.005% (w/w) of the mixture or composition.

### BRIEF DESCRIPTION OF THE DRAWINGS

FIG. 1: Methods of producing plastic articles in accordance with embodiments of the present disclosure.

FIG. 2: Protein-binding ability of a plastic article prepared in accordance with one embodiment of the disclosure compared to that of a commercially available plastic article.

### DETAILED DESCRIPTION

The present inventors have developed resin modifier compositions and functional resin compositions based on thermoplastic resins that are useful in the preparation of plastic articles. The surface of the articles can be tuned to possess antimicrobial, antiviral and/or antifouling properties. The antimicrobial, antiviral and/or antifouling properties are in-built into the surface and do not rely on the migration of biocides, the use of surface coatings or chemical depletion of the articles. In addition, the performance of the articles is stable in that the efficacy of microbial, viral and/or fouling resistance is minimally impacted by the surface morphology of the article, the composition of the contacting medium and external environmental stresses, such as for example irradiation and repeated cycles of autoclaving and washing. The articles provide significant advantages over those of the prior art in that they are not susceptible to delamination or wear and their antimicrobial, antiviral and antifouling properties do not degrade over time.

### Compositions

In one aspect there is provided a thermoplastic resin modifier composition comprising, consisting of, or consisting essentially of:
(i) a vinyl monomer;
(ii) a co-polymerisable anhydride;
(iii) a thermal free-radical polymerisation initiator; and
(iv) a thermoplastic resin.

The composition may comprise at least 85% (w/w), or at least 86% (w/w), or at least 87% (w/w), or at least 88% (w/w), or at least 89% (w/w), or at least 90% (w/w), or at least 91% (w/w), or at least 92% (w/w), or at least 93% (w/w), or at least 94% (w/w), or at least 95% (w/w), or at least 96% (w/w), or at least 97% (w/w), or at least 98% (w/w) of the thermoplastic resin. In some embodiments the composition comprises between about 85% (w/w) and about 98% (w/w), or between about 86% (w/w) and about 98% (w/w), or between about 87% (w/w) and about 98% (w/w), or between about 88% (w/w) and about 98% (w/w), or between about 89% (w/w) and about 98% (w/w), or between about 90% (w/w) and about 98% (w/w), or between about 91% (w/w) and about 98% (w/w), or between about 92% (w/w) and about 98% (w/w), or between about 93% (w/w) and about 98% (w/w), of the thermoplastic resin.

The co-polymerisable anhydride may be an organic acid anhydride of the following general formula (I), in which R₁ and R₂ are organic residues.

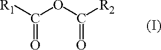

R₁ and R₂, together with the carbons to which they are attached and the central oxygen atom, may form a ring structure. The ring structure may be mono-, bi, tri- or tetracyclic. Non-limiting examples of organic anhydrides include maleic anhydride, phthalic anhydride, tetrahydrophthalic anhydride, naphthalenetetracarboxylic dianhydride, and their isostructural analogues, including maleimides (such as for example, maleimide, norbornene dicarboximide, N-carbethoxymaleimide, N-carbamylmaleimide, N-phenylmaleimide, N-(4-carboxyphenyl)maleimide and N-ethylmaleimide with different N-substituents), maleinates (such as for example, dibutyl maleate and ricinoleic oxazoline maleate), fumaric acid, and anhydride, ester and imide derivatives of citraconic and itaconic acids.

In one embodiment the vinyl monomer comprises one or more moieties having antimicrobial, antiviral or antifouling properties. Moieties having antimicrobial, antiviral or antifouling properties include, for example, hydroxy, amino, carboxyl, ether, substituted ring, fused ring and heterocyclic groups. Some of the moieties is typical of a surfactant structure composed of hydrophilic and hydrophobic units. Non-limiting examples of antimicrobial and anti-viral moieties include, but are not limited to, natural peptides, N-substituted amides, squalenes, tannins, saponins, flavonoids, alkaloids, steroids, lactones, lectins, lactams, pilicides, curlicides, alkyl glycosides, aminoglycosides, glycopolymers, glycolipids, sugar esters, quaternary ammonium compounds, terpenes, terpenoids, fatty acids, fatty acid esters, alkyl amines, alkyl amine oxides, alcohol alkoxylates, nitroxides, halamines, diaryl ethers, xanthones, quinones, coumarins, polyacetylenes, guanidines, halogens, phospho derivatives, sulfo derivatives, phenolic derivatives, benzoic derivatives, organometallics, pyridinium derivatives, piperazine derivatives, pyrrolidone derivatives, aniline derivatives, biguanides and related compounds, oximes and related compounds, isothiazolinones and related compounds, indole derivatives, heteroazole derivatives, heteroazoline derivatives, hydrazide-hydrazone derivatives, pyrans and related compounds, furans and related compounds, macrolides, tetracyclines, oxazolidinones, quinolones, amidoximes, amidoamines, and polypropylene imines.

In some embodiments the vinyl monomer is a short-chain alkene, a styrene, an alkyl acrylate, an alkyl acrylate ester, a vinyl acetate, a vinyl alcohol, a vinyl phenol, a vinyl alkyl ether, a vinyl halide, a vinylacetic acid, an acrylonitrile, an acrylamide, a vinyl silane, a vinyl sulfide, a vinyl sulfone, a vinyl sulfoxide, a vinylethylene carbonate, a vinylpyrrolidone, a vinylcarbazole, a vinyl norbonene, an unsaturated fatty acid, or an unsaturated fatty acid ester.

In alternative embodiments the vinyl monomer is one or more of the following monomers:

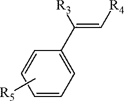

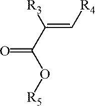

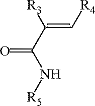

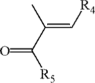

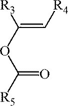

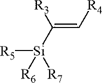

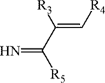

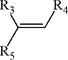

in which R₃ to R₇ are independently selected from: H, C₁-C₁₀ alkyl, phenyl, halogen, OH, cyano, and OC₁-C₆ alkyl, and wherein the monomers each optionally comprise, or are conjugated with, one or more of: a natural peptide, a N-substituted amide, a squalene, a tannin, a saponin, a flavonoid, an alkaloid, a steroid, a lactone, a lectin, a lactam, a pilicide, a curlicide, an alkyl glycoside, an aminoglycoside, a glycopolymer, a glycolipid, a sugar ester, a quaternary ammonium compound, a terpene, a terpenoid, a fatty acid, a fatty acid ester, an alkyl amine, an alkyl amine oxide, an alcohol alkoxylate, a nitroxide, a halamine, a diaryl ether, a xanthone, a quinone, a coumarin, a polyacetylene, a guanidine, a halogen, a phospho derivative, a sulfo derivative, a phenolic derivative, a benzoic derivative, an organometallic, a pyridinium derivative, a piperazine derivative, a pyrrolidone derivative, an aniline derivative, a biguanide and related compounds, an oxime and related compounds, an isothiazolinone and related compounds, an indole derivative, a heteroazole derivative, a heteroazoline derivative, a hydrazide-hydrazone derivative, a pyran and related compounds, a furan and related compounds, a macrolide, a tetracycline, an oxazolidinone, a quinolone, an amidoxime, an amidoamine, and a polypropylene imine, or any combination thereof.

Thermal free-radical polymerisation initiators are well known to those skilled in the art and include, for example, peroxides and azo compounds. Examples of suitable peroxides include diacyl peroxides (such as benzoyl peroxide and dilauroyl peroxide), dialkyl peroxides (such as di-t-butyl peroxide and dicumyl peroxide), peresters (such as t-butyl perbenzoate), ketone peroxides (such as methyl ethyl ketone peroxide), and commercial organic peroxides sold under the tradenames Peroxan®, Benox®, Curox®, Norox®, Akroform®, Enox®, Luperox®, Trigonox®, Perkadox®, Laurox® and Butanox®. Examples of suitable azo compounds include azobisisobutyronitrile (AIBN), 1,1′-azobis(cyclohexamecarbonitrile) (ACHN), and commercial azo products sold under the trade name Vazo™ or supplied from Vesta Chemicals and Fujifilm Wako Chemicals.

Other than considering the reaction temperature and the particular thermoplastic resin modifier composition, a suitable thermal free-radical polymerisation initiator is selected based on several factors, including its oil/water-solubility (with respect to liquid vinyl monomers), efficiency factor, decomposition half-life time, hydrogen abstractability, stability of primary radicals, formation of decomposition by-products and susceptibility towards induced/redox decomposition, that determine graft versus non-graft polymerisation, thus controlling the efficiency, degree, length, distribution, microstructure and sequence of grafting of the vinyl monomer and co-polymerisable anhydride onto a polymer backbone against many probable side reactions that end up cage reaction, beta-scission, premature termination of radicals/propagating chains and chain transfer reactions into less reactive intermediates. Suppressing those side reactions may help prevent undesirable post-processing observations such as gel formation, discoloration, odour, blooming and significant alteration of melt flow index and physical properties of a thermoplastic resin.

Peroxide-based initiators are generally more prone to graft reaction and branch/crosslink formation via hydrogen abstraction or intramolecular back-biting of a hydrocarbon species but less susceptible to formation of linear polymers than azo initiators. For completion of graft reactions, the total reaction time or the residence time incurred inside melt processing equipment is preferably in the range of about 1 to 4 times of the half-life time of the initiators at the desired reaction temperature when determining the optimal regime of thermal processing. While melt processing, such as reactive extrusion, may usually involve a progressively increasing profile of temperatures from the front (i.e. feed zone and transition zone) to the rear (i.e. the metering zone and die zone) of a screw extruder, utilisation of a mixed system of one shorter-lived initiator, such as benzoyl peroxide, and one longer-lived initiator, such as dicumyl peroxide, at a molar ratio between 20:80 and 80:20 in the composition may maintain high initiating efficiency and grafting rate throughout the polymer melt compounding process.

Organic peroxide-based initiators span a broad range of decomposition half-life time and solubility. Following is a list of generic classes of peroxide-based initiators which are arranged in an ascending order of decomposition half-life time: peresters, peroxydicarbonates, alkylperoxy carbonates, diacyl peroxides, perketals, ketone peroxides, peracids, dialkyl peroxides, hydroperoxides and silyl peroxides.

In a preferred embodiment, the vinyl monomer is an electron donor with a high-electron-density double bond and a hydrophobic molecule, such as for example styrene, α-methylstyrene, vinyl naphthalene, isobutylene, vinyl norbornene, butyl vinyl ether and 2-chloroethyl vinyl ether, by bearing at least one electron-donating substituent. When preparing the modified thermoplastic resin composition, the vinyl monomer tends to copolymerize with the anhydride, an electron acceptor and a hydrophilic molecule, into an alternating or random segmented copolymer that imparts strong amphipathic character.

The as-formed copolymers in the modified thermoplastic resin composition are anchored as multiple short branches on the main chains of the thermoplastic resin leading to a hairy or comb-like architecture so that they are surface active and will migrate freely to the surfaces upon contact with either dry or wet environment to generate foul release and self-cleaning effects at the surfaces. While they are attached covalently to the substrate, this will not cause any leaching problems.

The anhydride moieties on the chemical graft, which are reactive and hydrolysable, are bi-functional in nature. They can serve on one hand to capture and bond chemically with additive compounds bearing alcohols, amines and nucleophiles leading to some hyperbranched microstructures and on the other hand serve to improve adhesion or compatibilisation with other polar thermoplastic materials which may give rise to toughened alloys. Such an approach is superior to the alternative use of commercial coupling agents, such as acrylic modified polyolefin, polyolefin-graft-maleic anhydride resin, polyolefin-graft-glycidyl methacrylate resin and some random copolymers of styrene, maleic anhydride and N-phenylmaleimide, which are available in various grades under the trade name of Auroren® (Nippon Paper Industries), Polybond™ (ChemPoint), Licocene® (Clariant), Epolene® (Eastman Chemicals), Exxelor™ (ExxonMobil), A-C® (Honeywell), Graftabond™ (Graft Polymer), Xiran® (Polyscope Polymers), IP (Denka), Bondyram® (Polyram), Lustran (Styrolution), Amplify™ (Dow) Orevac® (Arkema), Lotader® (Arkema) and Elvaloy® (DuPont). Although the latter looks to be simpler, the two approaches result in different polymer microstructures. For the latter, the coupling agents only provide immobilised reactive anchors of anhydride or carboxylic acid groups after being dispersed in the matrices of the thermoplastic resin, but not open-ended protruding arms that are able to segregate from the bulk matrices and create a self-adaptive brush-like topology with rapid surface reconstruction of hydrophobic/hydrophilic units or short segments at short time scales, as in the present disclosure. While the graft length is uncontrolled and polydisperse in nature, grafts with mixed chain lengths will extraordinarily enhance the fouling resistance of the substrate surfaces by blocking adsorption of small solutes, which are able to diffuse into the voids and interstices of the tethered brush, by an under-brush layer comprising shorter chains and offsetting the adverse effect of a reduced surface density of longer chains.

The alternation tendency of graft copolymerisation of the vinyl monomer (as donor) and the anhydride (as acceptor) is related to the feed ratio of the thermoplastic resin modifier composition and on the overall monomer conversion. If the overall monomer conversion is below 15%, an alternating polymer can be obtained from a composition feed containing from 30 to 70% by mol of the acceptor. If the overall monomer conversion is above 80%, strictly alternating copolymers are usually obtained from equimolar or nearly equimolar feed ratios. Chain-to-chain composition deviations are unavoidable however, when non-equimolar feeds are used. Apart from controlling the feed ratio between the vinyl monomer and the anhydride of the thermoplastic resin modifier composition, three other conditions may favour the alternation of such a binary system and achieve higher graft efficiency: (i) the product of the reactivity ratios of the two components (r1 and r2) falls between 0 and 1, which r1 and r2 are non-zero and reasonably close with r1:r2 (r1≧r2) not more than 60:1, and more preferably approaches to zero; (ii) their e coefficients according to Alfrey-Price Q-e scheme, where Q expresses the monomer reactivity (a measure of resonance stabilisation) and e is its polarisation (a measure of polar effects), are large in difference and are more preferably large in magnitude and of opposite sign; and (iii) the reactivity of the vinyl monomer or the anhydride towards the polymer macroradicals of the thermoplastic resin is preferably greater than its counterpart, such as its ability to form a stable macroradical and the resulting radical copolymerizes readily with its counterpart leading to grafted molecular complexes. For instance, styrene is a preferential choice of a vinyl monomer which is capable to generate a stable styryl macroradical. The reactivity ratio, Q coefficient and e coefficient of styrene and maleic anhydride, a typical donor-acceptor monomer pair with comparable Q coefficients, are reported to be (0.04, 1, -0.8) and (0, 0.86, +3.69), respectively and therefore have a strong tendency to produce an alternating graft at equimolar feed ratio. It is in principle feasible by having more than one type of vinyl monomer being exploited as a comonomer, such as vinyl acetate, acrylamide, N-isopropylacrylamide, N-vinyl pyrrolidone, N-methylolacrylamide, acrylamidoglycolic acid, acrylonitrile, methacrylic acid, methyl methacrylate, 2-hydroxyethyl methacrylate, 2-aminoethyl methacrylate, 2-(dimethylamino)ethyl methacrylate, 3-methacryloxypropyltrimethoxysilane, 2-carboxyethyl acrylate, 2-azepane ethyl methacrylate, glycidyl methacrylate, 2-vinylpyridine, 4-tert-butoxystyrene and 4-vinylcatechol acetonide with an intermediate polarity between the primary monomer and the anhydride in the composition feed. The last two comonomer examples can be deprotected subsequently with a Lewis/Brønsted acid to form phenol and catechol moieties on the graft and display potent antioxidant and antimicrobial activities. Compared with the anhydride, bifunctional comonomers, such as N-methylolacrylamide and acrylamidoglycolic acid, are latent coupling agents, and epoxy-bearing comonomers, such as glycidyl methacrylate, are versatile reactive coupling agents. At least one of the vinyl monomers in a comonomer mixture is preferably an electron donor with a more negative e coefficient in order for multicomponent copolymerisation to proceed so that it likely results in an acceptor-donor-acceptor terpolymer graft structure.

In some embodiments, the thermoplastic resin is an addition polymer. Addition polymers are polymers formed by the linking of monomers without co-generation of other products, and are well known to those skilled in the art. In another embodiment the thermoplastic resin is a polyolefin elastomer (POE). POEs are elastomers that are based on a polyethylene backbone and are also well known amongst those skilled in the art. In a further embodiment the olefin-bearing thermoplastic resin is a rubber. The rubber may be natural rubber or a synthetic rubber.

In some embodiments, thermoplastic resins include, but are not limited to: polyethylene (PE), polypropylene (PP), polybutylene (PB), cyclic olefin copolymer (COC), polymethylpentene (PMP), polyvinyl butyral (PVB), polyacrylonitrile (PAN), nitrile rubber (NBR), ethylene propylene rubber (EPR), poly(ethylene-co-1-octene), poly(ethylene-co-1-hexene), neoprene, polyisoprene (PI), poly(styrene-ethylene-butylene-styrene) (SEBS), poly(styrene-ethylene-propylene-styrene) (SEPS), poly(styrene-butadiene-styrene) (SBS), styrene-isoprene block copolymers (SIS), methyl methacrylate-butadiene-styrene (MBS), acrylonitrile butadiene styrene (ABS), ethylene butyl acrylate copolymer (EBA), ethylene vinyl acetate (EVA), ethylene vinyl alcohol (EVOH), ethylene acrylic acid (EAA), ethylene methyl acrylate (EMA), ethylene propylene diene monomer (EPDM), ethylene tetrafluoroethylene (ETFE), ethylene chlorotrifluoroethylene (ECTFE), ethylene-vinyl chloride (EVCL), an olefin metathesis product, including combinations thereof.

In a preferred embodiment, thermoplastic resins are medium-to-high-flow homopolyolefins, multiblock copolymers and random copolymers, as well as blends of such copolymers derived from two or more monomer species, and exhibit uniformly dispersed while small-sized domain morphologies driven by phase separation and/or crystallisation in heterogeneous systems. Melt flow indexes of thermoplastic resins are more preferably 5 g/10 min (190° C./2.16 kg) or above. It is known that impact and high gloss performance of thermoplastic resins depends on the degree of crystallinity. The crystallinity decreases with decreasing stereo-regularity, and the material shows higher elasticity but less haze. A number of methods are known for controlling phase separation and crystallisation, such as by introducing stereo defects, by short-chain branching, by introducing a comonomer and by speeding up crystallisation and increasing the number of nuclei formation through addition of nucleating agents. Thermoplastic resins are preferably amorphous or low-crystalline grades of thermoplastic elastomers and poly-alpha-olefins. A majority of these commercial resins comprise primarily ethylene- and/or propylene repeat units with examples, such as Vistamaxx, Exact, Optema, EMAC, EBAC, Notio, Tafmer, Vestoplast, Lutene, Lumicene, L-Modu, Versify, Engage, Elvax, Lotryl, Evatane, Elvaloy AC, Clyrell, Tafthren, Tefabloc, Kraton G, etc.

The vinyl monomer, the co-polymerisable anhydride, the thermal free-radical polymerisation initiator and other additives may not dissolve well with each other. This may be assisted by mixing them in an organic solvent or a solvent mixture at a weight ratio from about 1:3 to 1:2 with respect to co-polymerisable anhydride, followed by compounding with the thermoplastic resin before melt processing. The solubility may be adjusted through addition of one or more of solvents with different polarities and inertness towards the initiator. Examples of solvents include carbon tetrachloride, isopropyl alcohol, tetrahydrofuran, ethyl acetate, benzene, toluene, methyl ethyl ketone, o-dichlorobenzene, dimethyl formamide, N,N-dimethylacetamide, N,N-dimethylaniline, 4,N,N-trimethylaniline, dimethyl sulfoxide, triphenyl phosphite, tris(nonylphenyl) phosphite, caprolactam, liquid paraffin, odorless mineral spirit, isododecane, cumene, 1,3-diisopropylbenzene, cyclohexylbenzene and some highly branched isocetanes. The kind of solvents selected may, to some extent, regulate the polymerisation versus grafting of the vinyl monomer and the co-polymerisable anhydride onto the polymer backbone of the thermoplastic resin, depending on their polarities, polarizabilities, volatilities, electron donating/withdrawing abilities and chain transfer constants. Solvents containing nitrogen, phosphorus or sulfur atoms and derived such as from amides, lactams, carbamates, amine oxides, phosphites, phosphates, phosphonates, phosphoramides, phosphine oxides, monosulfides, sulfoxides, aryl disulfides, and thiazyl disulfides, may act as an electron donor and inhibitor of crosslinking (gelation), degradation and homopolymerisation of electrophilic monomers or anhydrides but promotor of graft copolymerisation. Such an effect may be facilitated through small dosage of a free radical/dioxygen scavenger, an active chain transfer agent or a co-catalyst to interact with the primary radicals, monomer radicals and macroradicals, such as p-benzoquinone, benzophenone, lithium phenyl-2,4,6-trimethylbenzoylphosphinate, benzotriazole, hydroxyphenyltriazine, quinone methide, 4-hydroxy-2,2,6,6-tetramethylpiperidine-1-oxyl, 2-cyano-2-propyl benzodithioate, butylated hydroxytoluene, dipentamethylenethiuram tetrasulfide, tris(2,4-di-tert-butylphenyl)phosphite, octyl tin mercaptide, octyl tin carboxylate, dibutyl phthalate, stearamide, ascorbic acid, thiobarbituric acid, N-acetoxy-phthalimide, BlocBuilder®, Evabopol®, zinc salts, iodonium salts, sulfonium salts and compounds derived from mercaptans, thioethers, thiocarbonates, thioesters, thiocarbamates, xanthates, sulphonylureas, alkoxyamines, imidazolyl nitrones, polyunsaturated fatty acids, hindered phenolics, hindered amines, organosilicon hydrides, organoboranes, aluminium alkyls, persulfates, ylides, metal ylide complexes and transition metal (II) (such as Sn(II), Sb(III), Pb(II), Bi(III), Fe(II), Ti(II), Ti(III), Mn(II), Mn(III), or Ge(II)) complexes, in the range from about one- to two-tenth parts by weight of the thermal free-radical polymerisation initiator.

Deodorants may be included in an amount between 0.5% (w/w) and 1% (w/w) with the purpose to absorb or neutralise traces of acrid odour due to unreacted/vaporised anhydrides or acids, outgassing of volatile impurities and other reactions engaging functional groups of amines and sulfurous components, such as hydrogen sulfide, mercaptans and thioethers, during melt processing. Suitable examples of a deodorant include bentonites, activated carbons, metal-exchanged zeolites, potassium alums, silica gels, talcum powders, alkaline sorbents, mica, diatomaceous earth, and some other commercial products available in the market, such as TEGO sorb® which contains zinc ricinoleate, Recycloblend® which contains oxirane reactive groups and Struktol® RP 17.

The thermoplastic resin modifier composition may be prepared by combining the thermoplastic resin (which may be in granule or powder form), the vinyl monomer (which may be in a liquid or paste form) the co-polymerisable anhydride and the thermal free-radical polymerisation initiator in the following amounts:
Thermoplastic resin: about 90% (w/w) to about 98% (w/w)
Vinyl monomer: about 0.5% (w/w) to about 4% (w/w)
Co-polymerisable anhydride: about 0.5% (w/w) to about 4% (w/w)
Thermal free-radical polymerisation initiator: about 0.05% (w/w) to about 2% (w/w)

The resulting mixture may then be subjected to oscillatory shaking or mechanical agitation in an enclosed chamber. Mixing on a kilogram production scale may be conducted more uniformly with the assistance of mixing, coating and size reduction apparatus, such as for example a blade mixer, a ribbon mixer, a 3-dimensional rotating drum mixer, a Banbury mixer, a dispersion kneader, a solid pan coater, a fluidized bed powder coater, an atomizer, a powder spray coater, a cryogenic or non-cryogenic plastic pulverizer or a ball miller, that is preferably equipped with temperature control and inert gas feeding to minimise shear heating effects.

The modified thermoplastic resin composition may then be prepared by melt processing the thermoplastic resin modifier composition. Melt processing may involve one complete cycle of heating (melting) and cooling (solidification), with the method encompassing four major modules: (a) a feeding unit; (b) a melting/conveying unit; (c) a sizing/cooling unit; and (d) a winding/pelletizing/shape forming unit. Granule or pellet forms of solid resins can be ground into fine powders to enhance uniformity of mixing with other starting materials. Solid and liquid forms of starting materials may be separately fed into the melting/conveying unit, for example a screw-type extruder, if the machine is equipped with an automatic liquid feeder, a metering pump or any high precision dosing unit (which can be volumetric, optometric and gravimetric) may be included for continuous production. In the case of a larger quantity of liquid reagents, dry blending over the resins will lead to dripping of liquid when the solid-liquid mixture settles over time in the feeding unit. As most vinyl monomers are soluble in non-polar organic solvents, one may therefore utilise porous, organo-modified inorganic products, such as clay, talc, zeolite, silica, aerogel, fly ash, etc. or a thermodegradable polyolefin hydrocarbon superabsorbent (so-called “petrogel”) that exhibits rapid and high oil uptake capacity over its weight while releasing liquid reagents, or even ruptures for burst release upon heating at elevated temperatures. The superabsorbent can be fine polypropylene fiber or lightly crosslinked polyolefin copolymer containing one or more of a short-chain aliphatic hydrocarbon (say ethylene, 1-hexene, 1-octene, 1-decene, etc.), styrene and divinylbenzene unit. Apart from an extruder, it is possible to consider highly localized, rapid melting of thermoplastic resins using microwave radiation as a means of forming and welding along with the use of microwave receptive additives, such as talc, zinc oxide, carbon black, carbon fiber, carbon nanotube, polyethylene glycol etc. as a way of increasing the susceptibility of common plastics to microwave processing.

In some embodiments the cooling unit is a circulating water bath for cooling and solidification of melt extrudate from a screw-type extruder. If desired, this liquid bath can be transformed to a chemical bath of reagents and/or equipped with surface modification and pH/temperature/oxidation-reduction potential control units, such as in-liquid plasma generator, alkaline electrolyzer, hydrogen-rich water generator, reactive oxygen and nitrogen species (ROS/RNS) generator, horn for ultrasonic processor, etc. Examples of ROS/RNS include superoxide (O2·—), hydroxyl (·OH), peroxyl (RO2·), and alkoxyl (RO—), as well as hypochlorous acid (HOCI), ozone (O₃), singlet oxygen (¹O₂), and hydrogen peroxide (H₂O₂), which are non-radicals. These non-radicals are either oxidizing agents or easily converted into radicals. Nitrogen-containing oxidants include nitric oxide (NO·) peroxynitrite (ONOO·), nitrogen dioxide (NO₂). Such an additional process would not only be able to remove free residual compounds, but also tune the wetting property of the as-produced thermoplastic resins, which are relatively hydrophobic, so that polar additives could be trapped/deposited and dispersed more uniformly within the solid matrix. One example is a sonicating liquid bath formulated with inorganic metal salts (for example, carboxylates, halides, nitrates, sulfides, etc.), alcohol (for example, ethanol) and fatty acid/ammonium/polymeric compounds (for example, ethanolamine, hexamethylenetetramine, oleic acid, polyvinyl alcohol, polyethylene glycol, polyvinyl pyrrolidone, etc.) being exploited as a precursor, co-solvent, and capping agent, respectively at a salt concentration of 0.1 - 1 M and to form a metal oxide nanostructured layer over the resin surface via sonochemistry. The bath pH can be adjusted to 5 to 8 by adding sodium hydroxide, ammonia, acetic acid or naturally alkalizing mineral stones.

In another embodiment, the modified thermoplastic resin composition may be produced by solvent-assisted solid-phase polymerisation at a lower processing temperature in lieu of melt processing, in particular for soft and rubbery thermoplastics, temperature- or shear-sensitive viscous materials, all-powder mixes, wet pastes, emulsions or a manufacturing facility where advanced processing equipment, such as an underwater pelletizer, resonant acoustic mixer, ultrasonic homogenizer, centrifugal mixer, pugmill, marumerizer, high shear granulator, basket granulator, twin-dome extruder, planetary roller extruder and some specialised twin-screw extruders comprising a combination of distributive/dispersive elements and screw profiles/intermeshing design configurations, may not be available.

The thermoplastic resin is placed in a porous thimble which is mounted onto a Soxhlet extractor and allowed to be purified in an inert gas environment against a heating bath of preferably volatile solvent in the receiving flask, such as for example carbon tetrachloride, hexane, petroleum ether, ether and toluene until the resin grains are swollen and nearly saturated with the solvent without appreciable weight change. Unreacted monomers, soluble low-molecular-weight fractions and organic impurities may be removed in the washing process. Next, the swollen grains are soaked in an ether solution under a continuous nitrogen flow (10-30 ml s⁻¹) and at a temperature of 23 to 30° C. (±1° C.) to uptake the vinyl monomer, the co-polymerisable anhydride and the thermal free-radical polymerisation initiator from the solution as prepared beforehand at the desired weight composition of the three aforesaid ingredients. The initiator preferably demonstrates a higher self-accelerating decomposition temperature with a decomposition half-life of about an hour between 60 and 80° C. Examples of initiators that match such properties include AIBN, dilauroyl peroxide and dicetyl peroxydicarbonate. Ether solvent is allowed to be vented during the soaking process until it is mostly vaporised. The grains impregnated with the vinyl monomer, the co-polymerisable anhydride and the thermal free-radical polymerisation initiator are subsequently heated to the 1-hour half-life temperature and reacted for 1 to 1.5 hours before cooling in an ice bath to room temperature. The modified grains are collected and purified by Soxhlet extraction for at least 8 hours against ether to remove unreacted constituents and self-polymerised by-products in an inert gas environment.

The modified thermoplastic resin composition may be used to prepare a functional resin composition by combining the modified thermoplastic resin composition with one or more additives to form a mixture, and subjecting the mixture to melt processing. In one embodiment, the one or more additives may be additives that are typically included in a masterbatch. Suitable additives include, but are not limited to: catalysts, pigments, gloss enhancers, antioxidants, photostabilizers, impact modifiers, plasticizers, softening agents, crosslinkers, compatibilizers, fillers, antistatic agents, slip agents, antiblocks, anti-foggants, surfactants, flame retardants, optical clarifiers, rheology modifiers, fragrances and other processing aids, coupling agents and reagents that are vital to the physical properties of the core material constituting the plastic articles. The modified thermoplastic resin composition may be surface-pretreated with commercial spray-on, brush-on or wash-in durable water-repellent or surface finishing products, such as sold under Nikwax, Gear Aid, Ultratech International, Shi-Etsu, Huntsman, Texchem UK, Rust-Oleum NeverWet, Cytonix, Wuxi Shunye Technology, etc. to impart water/oil- and stain/dirt-proofing performance. The one or more additives may include a compound or compounds having antimicrobial, antiviral or antifouling properties. The antimicrobial, antiviral or antifouling properties may be imparted to the plastic article via the vinyl monomer as described above, and/or via inclusion of a compound or compounds having antimicrobial, antiviral or antifouling properties in the functional resin composition.

Whilst it is possible to prepare the functional resin composition in a single step by including the one or more additives in the mixture of components used to prepare the modified thermoplastic resin composition, splitting the process into two steps avoids free radical-induced degradation of additives, such as compounds based on alkylene oxides or their adducts of alcohols, polyunsaturated fatty acids, acid esters, etc. at elevated temperatures, which leads to autooxidation, discoloration and odour in the functional resin composition.

### Methods for Producing Plastic Articles

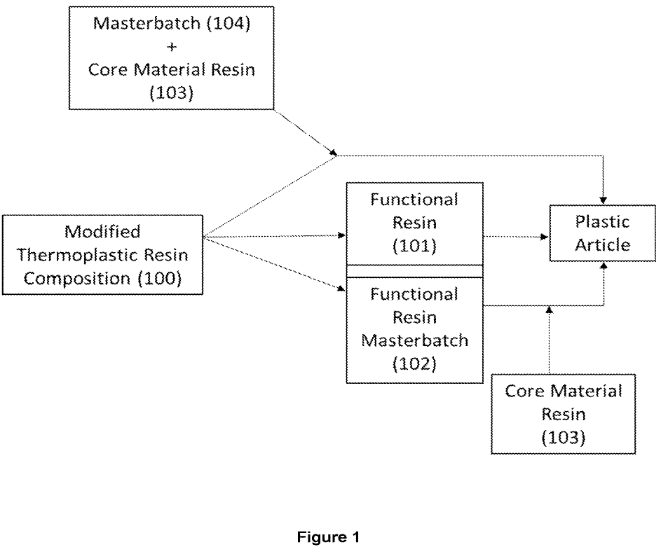

FIG. 1 summarises methods for preparing plastic articles in accordance with the present disclosure. In one embodiment, the modified thermoplastic resin composition 100 is converted to functional resin 101 by combining it with one or more additives. Functional resin 101 is then converted directly to the plastic article by shaping, such as for example by molding.

In an alternative embodiment, the modified thermoplastic resin composition 100 is converted to a functional resin which is a masterbatch (102) by proportionally increasing its ingredient content. The functional resin masterbatch 102 is then combined with an appropriate core material resin 103 (which reflects the core/basic plastic from which the plastic article will be produced) and melt processed to form the plastic article. By utilising this approach, the functional resin masterbatch 102 is able to be dry-blended with the core material resin 103 prior to melt processing to form the article. As a result, one may utilise a lower-melting temperature core material resin, such as polyolefin elastomer, as the bulk carrier of the additives in the functional resin masterbatch 102, so to minimise their chemical decomposition and the formation of by-products as much as possible. In some embodiments the ratio of the core material resin 103 to the functional resin masterbatch 102 is about 80 to 95 parts to 5 to 20 parts.

In a further embodiment, the modified thermoplastic resin composition 100 is combined with a masterbatch 104 and a core material resin 103, and converted directly into the plastic article using melt processing. In some embodiments the ratio of the core material resin 103 to the masterbatch 104 to the modified thermoplastic resin composition 100 is about 75 to 85 parts to 5 to 15 parts to 5 to 15 parts.

The core material resin may be any plastic material from which it is desired to produce the article. In some embodiments, the core material resin is one or more of the thermoplastic resins defined above.

The inventors have found that by varying surface energy, graft length, steric size and the charge of pendant groups on the vinyl monomers, as well as hardness of the resin modifier composition and the amount of resin modifier composition present in the core material that will constitute the plastic article, the performance of the article can be finely tuned to differentially control killing and/or repelling of microorganisms, viruses and accumulation of residual biological materials, such as blood stains, spores, pollens, proteins, enzymes, nucleic acids, extracellular polymeric substances, metabolites and disease-causing agents (for example, endotoxins and mycotoxins) from surrounding media. It has been found that the killing/repelling effect occurs not only on flat and smooth surfaces, but also on matte, curved, microporous and foam surfaces of the article. In addition, the killing/repelling effect is largely unaffected by environmental stresses, such as gamma ray/ultraviolet irradiation and repeated cycles of autoclaving and washing, thereby making the articles suitable for not only single-use disposable applications, but also reusable packaging, medical device and plastic labware applications. The articles are also biocompatible and safe for contact with food products. Advantageously, the articles do not require surface coatings and are therefore not prone to delamination.

The performance of the articles is tunable in that the articles may be antifouling, antimicrobial and/or antiviral as follows:
repelling microorganisms but not killing them;
killing microorganisms but not repelling them;
synergistically killing and repelling microorganisms;
repelling viruses and biological materials;
inactivating infectious viruses.

In the case of a bulk article preform that can be made of a different type of material to the thermoplastic resin compositions, surroundings or target surfaces of the substrate can be decorated with the functional resin compositions using insert molding, over-molding, multishot molding, hot melt lamination or bicomponent co-extrusion processes leading to core-sheath or bilayered profiles.

The inventors have found that where protein-resistance is desired, alcohol ethoxylates or alkylene oxide derived compounds, including oligomers/polymers of ethylene glycol, may be included in the functional resin composition. The resulting plastic articles prepared exhibit highly effective protein-binding resistance.

Several mechanisms are operating to impart protein-binding resistance of a plastic article, such as by exerting large excluded volume effects as well as entropic and osmotic repulsions attributed to high conformational mobility, high levels of hydration and low interfacial free energy by its underlying surfaces in contact with transport media. To do so, one effective way is to increase the hydrophilicity of the plastic substrate by incorporation of a hydrophilic additive, and preferably a superabsorbent polymer, so that it will impose stealth effect with formation of a durable and fast-acting hydrated layer on topmost surface exhibiting limited or weak interactions with plasma proteins and also low non-specific cellular uptake after covalent functionalisation of the substrate by the additive. The aforesaid additive, which should be readily hydrated/swollen and preferably water-soluble and less sensitive to pH and charged species, can either be a non-ionic or a charge-bearing substance. Oligomer/polymer of ethylene glycol, where at least one end is hydroxyl- or methoxy-terminated and another end is anhydride-reactive, is a preferred choice of a non-ionic hydrophilic additive. Other suitable examples include polyvinyl alcohol, polyglycidol, poly(N-isopropylacrylamide), poly(2-hydroxyethyl methacrylate), poly(N-[tris(hydroxymethyl)methyl]acrylamide), poly(2-methyl-2-oxazoline), poly(2-ethyl-2-oxazoline), polyphosphoester and derivatives. Suitable examples of a charge-bearing hydrophilic additive with desirable protein-binding resistance is either a betaine-type zwitterion, bearing one or more of a pendant group of phosphorylcholine, sulfobetaine, phosphobetaine and carboxybetaine with phosphonates (PO₃⁻), sulfonates (SO₃⁻ ) and carboxylates (COO⁻) and terminal amino acid (⁻OOC—C—NH₃⁺) that has both a positive-charged amino group and a negative-charged carboxyl group on the α-carbon atom, or a mixed-charge zwitterion, containing balanced positive- and negative-charged moieties in different monomer units or binding to the same carrier or solid support, such as laponite clay which is an inherently double-charged filler and a disc-shaped particle with positive charges on the rim and negative charges on the surfaces, or via electrostatically assembled layers of oppositely charged polyelectrolytes comprising both polyanions and polycations. Non-limiting examples of polyanions include polyacrylate (or carbomer), polystyrene sulfonate, poly(vinyloxy-4-butyric acid), poly(metaphosphoric acid), hyaluronan, polyglutamate, polyaspartate, polyalginate, caseinate, xanthan gum, arabic gum, carboxymethyl konjac glucomannan, k-carrageenan, pectin, carboxymethyl cellulose, dextran sulfate, chondroitin sulfate, keratin sulfate, fucoidan and Eudragit® L/S/FS series (Evonik Industries). Non-limiting examples of polycations include polyethyleneimine, poly(allylamine hydrochloride), polyvinylpyridine, polylysine, polyarginine, chitosan, gelatin, polyvinylamine, poly(tertiary amine) and Eudragit® E/RL/RS series (Evonik Industries). Charge-bearing compounds are generally less thermally stable than non-ionic ones. For longer processing time and processing temperatures reaching beyond 100° C., non-ionic compounds are preferred.

The inventors have also found that adjusting the hydrophilic-lipophilic balance (HLB) or the logarithm of the 1-octanol-water partition coefficient (log P) of the additive may enable the plastic article to impose either repelling or killing/deactivating or both actions towards approaching germs or viruses. This can be controlled by the HLB or log P value of the additive incorporated.

The additive may be an amphiphile, which is typically a linear molecule containing a polar head and a non-polar tail separated by some spacer units at various lengths and degrees of saturation and preferably, a superspreading/superwetting agent performed with rapid spreading of an aqueous solution over low-energy hydrophobic surfaces, such as for example T-shaped trisiloxane polyoxyethylene ether, and more preferably a Gemini surfactant which is biomimetic of the constituent of a phospholipid bilayer cell membrane, such as for example Gemsurf Alpha 142 which is a commercial product supplied by Chukyo-Yushi. Other commercial brands with similar Gemini structures include Surfynol® and TEGO® Twin from Evonik Industries. The higher HLB value (or more negative log P value) of the additive, the more hydrophilic and protein-binding resistance is the plastic article after incorporation. An additive with a HLB value of higher than 7 (or log P value lower than 4), and preferably a permeation enhancer, such as fatty acid monoglycerides, fatty acid alkyl esters, disubstituted amides, N-alkyl substituted lactams, glycerol/sorbitan esters, glycol esters and sugar esters with carbon chain lengths in the range of about 10-18 carbons, may interact with the protein or cells upon contact. Examples of commercial grades of permeation enhancers include Montane™, Miglyol®, Atmer™, Pationic®, Peceol® and Labrafil®.

The additives, which are affixed to the polymers of the modified thermoplastic resin composition, may be able to penetrate into the cell membranes of the bacteria or cell walls of the algae/fungi, thus causing death of a microorganism as a result of induced mechanical stress and curvature and subsequently disruption of permeability of the cell membrane/wall by intercalating additives beyond a threshold concentration. With a HLB value intermediate between 10 and 16, the additive may behave as both an anti-foulant and a biocide, hence exerting killing/deactivating and repelling actions synergistically. With a higher HLB value near to 20, the plastic article becomes entirely repellent and behaves similarly to a hydrophilic additive. Common classes of non-ionic surfactants include but are not limited to alcohol ethoxylates, alkyl phenol ethoxylates, alkyl aryl alkoxylates, alkyl amine ethoxylates, ethoxylated fatty acid alkanolamides, ethoxylated fatty amines, alkyl alkoxylate phosphate esters, aryl alkoxylate phosphate esters, ethylene oxide (EO)-propylene oxide (PO) block copolymers, poloxamers (Pluronics), EO/PO alkoxylates, fatty alcohol ethoxylates, fatty acid ethoxylates, ethoxylated triglycerides, sorbitan/glycerol ester ethoxylates, alkyl glucosides, dimethicone copolyols, polyether-modified polysiloxanes, ether-linked fluorosurfactants, or combinations thereof. Examples of amphoteric surfactants include but are not limited to alkyl amine oxides, alkylbetaines and alkylamidopropylbetaines. The amphiphilic additive is preferably a non-ionic or salt-free amphoteric surfactant but not an ionic detergent, either of positive or negative charge, such as sodium dodecyl sulfate, sodium dodecylbenzene sulfonate, sodium cholate, sodium deoxycholate, benzalkonium chloride, alkyl ether sulfates, alkyl sulfates, alkylbenzene sulfonates, alpha olefin sulfonates, phosphate esters, perfluorinated carboxylic acids, alkylamines, alkylimidazolines, alkoxylated amines, and other quaternary ammonium and amino acid-based compounds. The nature of the interaction of a protein with a surfactant molecule is both electrostatic and hydrophobic. When an ionic detergent is used as an additive, the polar head of the molecule, if dangling, can bind electrostatically to the oppositely charged residue on the protein. Thus, non-ionic and amphoteric surfactants are milder and less susceptible to protein denaturing than ionic detergents which are sometimes not desirable for certain applications as containers for protein storage. Commercial grades of non-ionic surfactants are mostly ethoxylated compounds, such as Triton™-X, Neodol®, Lutensol®, Ethylan®, Emulphogen®, Kolliphor®, Eumulgin®, Toximul®, Ninex®, Berol®, Emulsogen®, SilSense®, Tween®, Span®, Labrasol®, Lutrol®, Montanox™, Dynol™, Zonyl®, Capstone®, Chemguard, Myrj® and Brij®, with few non-alkoxylated (EO/PO-free) examples from Arlacel™, Disponil® and Simulsol™ series. Surfactants with low level of toxicity and high biorenewable carbon index are preferred. Ethoxylated surfactants having more than 4 EO units (hydrophilic content) and a log P value less than 3 are in general less conducive to bioaccumulation.

Any one or more of the compounds recited in paragraphs [00157] to [00161] above may be included as additives in masterbatches or functional resins as desired.

In another embodiment, an anti-biofilm, anti-viral agent or quorum sensing inhibitor may be included as an additive to provide secondary protection of a plastic article against microbial growth and/or viral activity at its surfaces. Such agents are originated mainly from biomass, naturally derived or biosynthetic compounds, including isoborbide mononitrate, S-nitrosothiol, which are nitric oxide donors and can induce biofilm dispersal, ivermectin, nucleoside analogues, pyroligneous acids, some phytochemical extracts, such as for example cinnamaldehyde, allicin, iberin, ajoene, linalool, citronellol, geraniol, eugenol, curcumin, coumarin, thymol, carvacrol, resveratrol, epigallocatechin gallate, quercetin, caffeine, menthol, vanillic acid, chlorogenic acid, salicyclic acid, flavaglines, ellagitannins, and some biosurfactants, such as for example lipopeptide, rhamnolipid, sophorolipid and microbial/algal exopolysaccharide. In another embodiment, an anti-biofilm, anti-viral agent, quorum sensing, c-di-GMP/c-di-AMP or proton pump inhibitor may be included as an additive to provide secondary protection of a plastic article against microbial growth and/or viral activity at its surfaces. Such agents are originated mainly from biomass, naturally derived or biosynthetic compounds, including isoborbide mononitrate, S-nitrosothiol, which are nitric oxide donors and can induce biofilm dispersal, ivermectin, nucleoside analogues, pyroligneous acids, some phytochemical extracts, such as for example cinnamaldehyde, allicin, iberin, ajoene, linalool, citronellol, geraniol, eugenol, curcumin, coumarin, thymol, carvacrol, resveratrol, epigallocatechin gallate, quercetin, caffeine, menthol, vanillic acid, chlorogenic acid, salicyclic acid, flavaglines, ellagitannins, benzimidazole derivatives, glycosylated triterpenoid saponins, and some biosurfactants, such as for example lipopeptide, rhamnolipid, sophorolipid and microbial/algal exopolysaccharide.

In some embodiments, catalysts are included in a masterbatch or the functional resin composition together with the additives to render post-modification of the modified thermoplastic resin composition. Catalysts can be bases with examples such as triethylamine, imidazole, 1,4-diazabicyclo[2.2.2]octane, 1,8-diazabicyclo(5.4.0)undec-7-ene, 1,5,7-triazabicyclo[4.4.0]dec-5-ene and N-heterocyclic carbene compounds, or acids with examples such as stearic acid, diphenyl phosphate, methanesulfonic acid, p-toluenesulfonic acid, triflic acid, dibutyltin dilaurate, tin (II) 2-ethylhexanoate, zinc (II) acetate and titanium (IV) butoxide. Urea, which decomposes in melt upon heating, is used as an ammonia source for imine formation on ketone or aldehyde moieties or amidation of anhydride or carboxylic acid moieties of the polymers in the modified thermoplastic resin composition. Silylating reagents, such as hexamethyldisilazane (HMDS), 1,3-bis(trimethylsilyl)urea (BSU) and trimethylsilyl chloride (TMSCI), are used as auxiliary agents to cap and hydrophobise a portion of the alcohol and carboxylic acid moieties of the polymers and minimise their competitive influences on the activities of catalysts. Chain extenders, such as diols, diamines, and more preferably heterobifunctional substances, such as ethanolamine, isosorbide mono(methyl carbonate), p-maleimidophenyl isocyanate, 3-aminopropyl triethoxysilane and polyethylene glycol monomethacrylate, bearing two different terminal groups either of alcohols, amines, halides, acyl halides, thiols, thioctic acids, carboxylic acids, carbonate esters, aldehydes, epoxies, isocyanates, acrylates, succinimidyl esters, maleimides, oxazolines, carbodiimides, silanes and dipeptides, may be included to improve chemoselectivity of the polymers towards specific kinds of functional groups of additives. The degree of flexibility of a chain extender can be controlled by the length and aliphatic/aromatic structure of spacer units. Compatibilizers, which are preferably condensation plastics, may be incorporated into the said composition to improve miscibility of the core material resin with the modified thermoplastic resin composition comprising both hydrophilic and hydrophobic constituents and may potentially give rise to toughening effects. Suitable examples include polyamides, polyesters, polycarbonates, polyurethanes, poly(amino acids), poly(ester amides), poly(amidoamines), poly(ether-block-amides), polyurethane ureas, polyimides, polyisocyanurates, polycarbodiimides, silicone resins, phenolic resins, urea-formaldehyde resins, epoxy resins and, more preferably, bioplastics or biodegradable polymers, such as polybutylene adipate terephthalate, polybutylene succinate, polylactic acid, poly(lactic-co-glycolic acid), polycaprolactone, polylysine, polyhydroxyalkanoates, most typically polyhydroxybutyrate and poly(3-hydroxybutyrate-co-3-hydroxyvalerate), and some other carbohydrate and protein derived thermoplastics, owing to their biocompatibility.

### EXAMPLES

The present disclosure is further described below by reference to the following non-limiting examples.

### Example 1 - Production of a Modified Thermoplastic Resin Composition (100)

Maleic anhydride (MA) and dicumyl peroxide (DCP), ground into powders before use, were stirred in styrene until the solids were partly dissolved. The resulting liquid dispersion was subsequently added over granules of an olefinic thermoplastic resin and the resulting mixture shaken in a rotating drum at ambient temperature until the liquid suspension was homogeneously spread over the granules. The resin mixtures were then melt-compounded in a co-rotating twin-screw extruder. The temperature profiles were set between 160° C. and 180° C., which is a common processing window for olefinic thermoplastic resins. The filament extruded from the die was drawn and solidified from melt upon cooling in water and then cut into pellets to give a modified thermoplastic resin composition (100).

### Example 2 - Conversion of a Modified Thermoplastic Resin Composition (100) Into a Functional Resin (101)

A liquid mixture of the modified thermoplastic resin composition (100), and other additives including Irganox® B 225 and alcohol ethoxylates (AEO-n) i.e. RO(CH₂CH₂O)ₙH (R = C12-14 alkyl and n=3-23 spanning a full range of HLB values between 7 and 18), were melt-compounded in the second pass of extrusion under the same temperature profiles described above in Example 1 to provide a functional resin (101) in the form of pellets.

### Example 3 - Injection Molding of Plastic Articles Based on Functional Resin (101) or a Mixture of Modified Thermoplastic Resin Composition (100), Masterbatch (104) and Core Material Resin (103)

Masterbatch (104) carrying the required additives was produced by extrusion under the same temperature profiles as described above in Example 1. Functional resin (101) or a mixture of modified thermoplastic resin composition (100), masterbatch (104) and core material resin (103) prepared either by dry or melt blending was fed into an injection molding machine which could be shape-formed into various types of plastic articles from the mold cavity.

Details of the plastic articles are given below in Table 1:

TABLE 1

| Composition Example | Modified Thermoplastic Resin Composition (100) | Functional Resin (101) | Masterbatch (104) | Pelletized Sample Prepared for Injection Molding |
|---|---|---|---|---|
| | Feed (%, w/w) | Feed (%, w/w) | Feed (%, w/w) | Feed (%, w/w) |
| 1 | Melt blend: | Melt blend: | n.a. | (101) (100%) |
| | 1. MA (2%) | 1. AEO-5 (0.3%) | | |
| | 2. DCP (0.5%) | 2. (100) (1.2%) | | |
| | 3. Styrene (2%) | 3. PPR-a (98.5%) | | |
| | 4. PPR-a (95.5%) | | | |
| 2 ⁴ | Melt blend: | Melt blend: | n.a. | (101) (100%) |
| | 1. MA (2%) | 1. AEO-5 (0.3%) | | |
| | 2. DCP (0.5%) | 2. (100) (1.2%) | | |
| | 3. Styrene (2%) | 3. B225 (0.15%) | | |
| | 4. PPR-a (95.5%) | 4. PPR-a (98.35%) | | |
| 3 ⁵ | Melt blend: | Melt blend: | n.a. | (101) (100%) |
| | 1. MA (2%) | 1. AEO-5 (0.3%) | | |
| | 2. DCP (0.5%) | 2. (100) (1.2%) | | |
| | 3. Styrene (2%) | 3. B225 (0.15%) | | |
| | 4. PPR-a (95.5%) | 4. PPR-b (98.35%) | | |
| 4⁶ | Melt blend: | n.a. | Melt blend: | Dry blend: |
| | 1. MA (0.4%) | | 1. Urea (0.2%) | 1. (100) (10%) |
| | 2. DCP (0.5%) | | 2. HMDS (0.4%) | 2. (104) (10%) |
| | 3. Styrene (2%) | | 3. SA (1%) | 3. PPH (80%) as Core Material Resin (103) |
| | 4. PPH (97.1%) | | 4. PPH (98.4%) | |
| 5 | Melt blend: | n.a. | Melt blend: | Melt blend: |
| | 1. MA (5.4%) | | 1. AEO-5 (8%) | 1. (100) (6.6%) |
| | 2. DCP (0.5%) | | 2. TPE-a (92%) | 2. (104) (3.4%) |
| | 3. Styrene (1.5%) | | | 3. TPE-a (90%) as Core Material Resin (103) |
| | 4. TPE-a (92.6%) | | | |
| 6 | Melt blend: | n.a. | Melt blend: | Melt blend: |
| | 1. MA (5.4%) | | 1. AEO-5 (8%) | 1. (100) (10%) |
| | 2. DCP (0.5%) | | 2. TPE-b (92%) | 2. (104) (5%) |
| | 3. Styrene (1.5%) | | | 3. TPE-b (85%) as Core Material Resin (103) |
| | 4. TPE-b (92.6%) | | | |
| 7⁶ | Melt blend: | n.a. | Melt blend: | Melt blend: |
| | 1. MA (2%) | | 1. MA (3%) | 1. (100) (20%) |
| | 2. DCP (0.5%) | | 2. DCP (0.8%) | 2. (104) (20%) |
| | 3. Styrene (2%) | | 3. PPR-a (67.3%) | 3. PA612 (60%) as Core Material Resin (103) |
| | 4. PPR-a (95.5%) | | 4. PPO (28.9%) | |

The abbreviations in Table 1 are as follows:
AEO-5 - alcohol ethoxylate (AEO-n) i.e. RO(CH₂CH₂O)ₙH, wherein R = C12-14 alkyl and n=5 with a reported HLB value of 10-11 and a hydroxyl value of 130-140 mg KOH/g (supplier: Shandong Usolf)
B225 - Irganox® B 225 (antioxidant)
DCP - dicumyl peroxide
HMDS - hexamethyldisilazane
MA - maleic anhydride
PA612 - polyamide 6,12 (Zytel® 158 NC010, Dupont)
PPH - polypropylene homopolymer (SKYLUX™ H530, DragonChem)
PPR-a - polypropylene random copolymer (Clyrell RC5056, LyondellBasell)
PPR-b - polypropylene random copolymer (Moplen RP6068, HMC Polymers)
PPO - propylene-based olefinic elastomer (Vistamaxx™ 6202, ExxonMobil)
SA - stearic acid
TPE-a - thermoplastic elastomer (Kraiburg TPE THERMOLAST® K HTF8326/415)
TPE-b - thermoplastic elastomer (Kraiburg TPE THERMOLAST® K TF7AAC)
See below in Table 3 for a description of footnotes 4 to 6 in Table 1.

### Example 4 - Protein Binding Characteristics of Plastic Articles Based on Functional Resin (101) or a Mixture of Modified Thermoplastic Resin Composition (100), Masterbatch (104) and Core Material Resin (103)

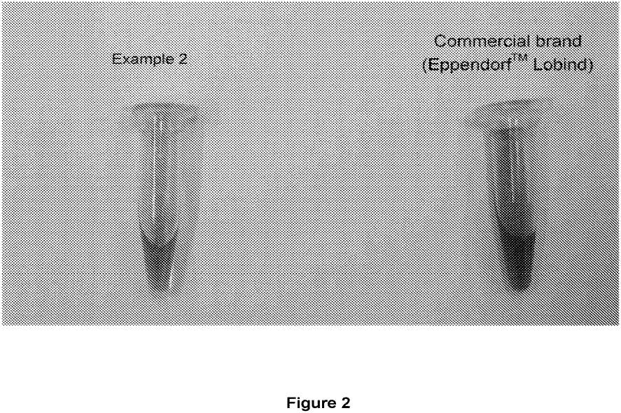

1.5 mL standard centrifugal tubes were produced by injection molding according to Example 3. The low retention performance of the tubes was compared with commercial benchmarks in terms of protein loss or recovery and ‘blank’ tubes as controls, i.e. not inoculated with the protein solution in the study. The results are summarised in FIG. 2 and Table 2 with experiments conducted respectively for a relatively short and a long contact time scale. It can be clearly concluded that one composition example, i.e. composition example 2, outperformed, or at least performed similarly to, the commercial benchmarks in exhibiting low protein binding characteristics.

The experiments for FIG. 2 were performed as follows: Bovine serum albumin (BSA) was used as the test protein. First, a concentrated 10 mg/mL of BSA solution was freshly prepared by dissolving BSA (flakes) in a 1 x PBS buffer solution (pH 7.2-7.4). 200 microliters of BSA solution was transferred with a pipetter into 5 centrifugal tube specimens, capped and allowed to stand still in upright position without agitation. After 10 minutes of incubation at room temperature, the BSA solution was slowly withdrawn with a pipetter from each specimen until there was no sign of solution residues. Then, 200 microliters of a commercial bicinchoninic acid (BCA) assay reagent, which was light green in colour, was added with a pipetter to each specimen plus the controls and moderately shaken. Assay screening was determined by a colour change of the sample solution from green to purple in proportion to concentration of protein leftovers. The colour turned to dark purple in the case of the commercial benchmark, while the colour was light purple in the case of centrifugal tubes made of composition example 2. The colours in the ‘blank’ tubes remained at the initial colour of BCA assay reagent.

The experiments for Table 2 were performed as follows: Human pooled serum (BF-ho-45, Bangfei Biological, 120 microliter), which was diluted with PBS buffer and then dispersed into a total of 12 sample tubes (1 millilitre per specimen, 3 specimens per sample type and storage condition), was used as protein test subject. The serum solution was collected from the sample tube after elapsed time in storage at 4° C. for 48 hours and 7 days respectively and then quantified with Bradford Assay Kit to calculate the amount of protein recovered from the sample tube against a standard curve of net absorbance measured at a given wavelength between 575 nm and 615 nm versus serum concentration in serial dilutions.

TABLE 2

% Average Protein Recovery

| Sample tubes (1.5 mL centrifugal tubes) | After 48 h, 4° C. (in dark) | After 7 days, 4° C. (in dark) |
|---|---|---|
| Composition Example 2 | 67.68% | 62.87% |
| Sarstedt® Low Binding Reaction Tubes | 69.05% | 60.62% |
| Eppendorf™ LoBind | 53.12% | 48.23% |
| PROKEEP Low Protein Binding Tubes | 53.58% | 45.07% |

### Example 5 - Antimicrobial and Antiviral Performance of Plastic Articles Based on Functional Resin (101) or a Mixture of Modified Thermoplastic Resin Composition (100), Masterbatch (104) and Core Material Resin (103)

Table 3 summarises the antimicrobial and antiviral performance of the as-molded test specimens of a collection of composition examples based on functional resin (101) or a mixture of modified thermoplastic resin composition (100), masterbatch (104) and core material resin (103). These examples clearly show promising observations. Composition example 2, in particular, exerts excellent killing/deactivating and repelling actions synergistically, while it is additionally proven to be biocompatible and safe for contact with food.

TABLE 3

| Composition Example | Antimicrobial (Germ-killing ¹ or Germ-repelling ²) / Antiviral ³ Performance of As-molded Test Specimens | | |
|---|---|---|---|
| | Test species | % Reduction | Negative control |
| 1 | E. coli | 99.997% ¹ | standard sterile PE film |
| | S. aureus | 99.987% ¹ | |
| 2 ⁴ | E. coli | 97.5% ¹ | untreated PPR-a specimen |
| | S. aureus | 96.8% ¹ | |
| | E. coli | 87.0% ² | untreated PPR-a specimen |
| | S. aureus | 98.7% ² | |
| | H3N2 (Influenza A virus) Host cell: MDCK | 99.95% ³ | untreated PPR-a specimen |
| 3 ⁵ | E. coli | 98.50% ² | untreated PPR-b specimen |
| | S. aureus | 99.90% ² | |
| 4 ⁶ | E. coli | 98.40% ² | untreated PPH specimen |
| | S. aureus | 35.90% ² | |
| 5 | E. coli | 99.73% ¹ | untreated TPE-a specimen |
| | S. aureus | 97.76% ¹ | |
| 6 | E. coli | 94.20% ² | untreated TPE-b specimen |
| | S. aureus | 99.99% ² | |
| 7 ⁶ | E. coli | 74.30% ¹ | untreated PA612 specimen |
| | S. aureus | 87.98% ¹ | |

¹ Germ killing efficacy. Tested by an accredited laboratory with reference to ISO 22196:2011/JIS Z 2801:2010.
² Germ repelling efficacy. Tested by an accredited laboratory with reference to T/GDPIA 1-2019/ASTM WK66122.
³ Virucidal activity Tested by an accredited laboratory with reference to ISO 21702:2019.
⁴ Example 2 was confirmed to pass the food contact safety tests under US FDA 21 CFR 177.1520 (d)(1), (d)(3)(ii) & (d)(4)(ii) and EU No 10/2011 in terms of overall migration in three simulants: 3% (w/v) acetic acid aqueous solution, 10% (v/v) ethanol aqueous solution and rectified olive oil all at 70° C., 2 h as well as specific migration of heavy metals in 3% (w/v) acetic acid aqueous solution at the same condition. The specimens (Example 3) also passed acute systemic toxicity test with reference to GB/T 16886.11-2011 and in vitro hemolytic test with reference to GB/T 16886.4-2003. All tests were conducted by accredited laboratories.
⁵ Example 4, AEO-n free in the composition, was able to demonstrate selectivity of repellency towards Gram-positive bacteria (S. aureus) and Gram-negative bacteria (E. coli).
⁶ Modified thermoplastic resin composition (100) was able to functionalise a condensation plastic, such as polyamide, with antimicrobial property to some extent.

The citation of any reference herein should not be construed as an admission that such reference is available as prior art to the present application. Further, the reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates.

Those skilled in the art will appreciate that the disclosure described herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations of an two or more of said steps, features, compositions and compounds.

1. A thermoplastic resin modifier composition comprising:
(i) a vinyl monomer;
(ii) a co-polymerisable anhydride;
(iii) a thermal free-radical polymerisation initiator; and
(iv) a thermoplastic resin.

2. The thermoplastic resin modifier composition of claim 1, wherein the vinyl monomer comprises one or more moieties having antimicrobial, antiviral or antifouling properties.

3. The thermoplastic resin modifier composition of claim 2, wherein the one or more moieties having antimicrobial, antiviral or antifouling properties are hydroxy, amino or carboxyl groups.

4. The thermoplastic resin modifier composition of claim 2, wherein the one or more moieties having antimicrobial, antiviral or antifouling properties are: a natural peptide, a N-substituted amide, a squalene, a tannin, a saponin, a flavonoid, an alkaloid, a steroid, a lactone, a lectin, a lactam, a pilicide, a curlicide, an alkyl glycoside, an aminoglycoside, a glycopolymer, a glycolipid, a sugar ester, a quaternary ammonium compound, a terpene, a terpenoid, a fatty acid, a fatty acid ester, an alkyl amine, an alkyl amine oxide, an alcohol alkoxylate, a nitroxide, a halamine, a diaryl ether, a xanthone, a quinone, a coumarin, a polyacetylene, a guanidine, a halogen, a phospho derivative, a sulfo derivative, a phenolic derivative, a benzoic derivative, an organometallic, a pyridinium derivative, a piperazine derivative, a pyrrolidone derivative, an aniline derivative, a biguanide and related compounds, an oxime and related compounds, an isothiazolinone and related compounds, an indole derivative, a heteroazole derivative, a heteroazoline derivative, a hydrazide-hydrazone derivative, a pyran and related compounds, a furan and related compounds, a macrolide, a tetracycline, an oxazolidinone, a quinolone, an amidoxime, an amidoamine, and a polypropylene imine.

5. The thermoplastic resin modifier composition of claim 1, wherein the vinyl monomer is a short-chain alkene, styrene, an alkyl acrylate, an alkyl acrylate ester, vinyl acetate, vinyl alcohol, vinyl phenol, a vinyl alkyl ether, a vinyl halide, vinylacetic acid, acrylonitrile, acrylamide, vinyl silane, an unsaturated fatty acid, or an unsaturated fatty acid ester.

6. The thermoplastic resin modifier composition of claim 1, wherein the vinyl monomer is styrene, α-methylstyrene, vinyl naphthalene, isobutylene, vinyl norbornene, butyl vinyl ether or 2-chloroethyl vinyl ether.

7. The thermoplastic resin modifier composition of any one of claims 1 to 6, comprising a plurality of vinyl monomers.

8. The thermoplastic resin modifier composition of claim 7, wherein the plurality of vinyl monomers are selected from the group consisting of: vinyl acetate, acrylamide, N-isopropylacrylamide, N-vinyl pyrrolidone, N-methylolacrylamide, acrylamidoglycolic acid, acrylonitrile, methacrylic acid, methyl methacrylate, 2-hydroxyethyl methacrylate, 2-aminoethyl methacrylate, 2-(dimethylamino)ethyl methacrylate, 3-methacryloxypropyltrimethoxysilane, 2-carboxyethyl acrylate, 2-azepane ethyl methacrylate, glycidyl methacrylate, 2-vinylpyridine, 4-tert-butoxystyrene and 4-vinylcatechol acetonide.

9. The thermoplastic resin modifier composition of any one of claims 1 to 8, wherein the co-polymerisable anhydride is an organic acid anhydride.

10. The thermoplastic resin modifier composition of claim 9, wherein the organic acid anhydride is maleic anhydride.

11. The thermoplastic resin modifier composition of any one of claims 1 to 10, wherein the thermal free-radical polymerisation initiator is a peroxide or an azo compound.

12. The thermoplastic resin modifier composition of claim 11, wherein the free-radical polymerisation initiator is a mixture of benzoyl peroxide and dicumyl peroxide.

13. The thermoplastic resin modifier composition of claim 12, wherein the benzoyl peroxide and the dicumyl peroxide are present in a molar ratio between about 20:80 and about 80:20.

14. The thermoplastic resin modifier composition of any one of claims 1 to 13, wherein the thermoplastic resin is a medium-to-high-flow homopolyolefin, a multiblock copolymer a random copolymer, or a blend thereof.

15. The thermoplastic resin modifier composition of any one of claims 1 to 13, wherein the thermoplastic resin is an addition polymer, a polyolefin elastomer, a thermoplastic olefin or a rubber.

16. The thermoplastic resin modifier composition of any one of claims 1 to 13, wherein the thermoplastic resin is PE, PP, PB, COC, PMP, PVB, PAN, NBR, EPR, PI, SEBS, SEPS, SBS, SIS, MBS, ABS, EBA, EVA, EVOH, EAA, EMA, EPDM, ETFE, ECTFE, EVCL, poly(ethylene-co-1-octene), poly(ethylene-co-1-hexene), neoprene, an olefin metathesis product, or any combination thereof.

17. The thermoplastic resin modifier composition of any one of claims 1 to 16, further comprising an organic solvent.

18. The thermoplastic resin modifier composition of any one of claims 1 to 17 further comprising a deodorant.

19. A method for preparing a modified thermoplastic resin composition, the method comprising: combining,
(i) a vinyl monomer;
(ii) a co-polymerisable anhydride;
(iii) a thermal free-radical polymerisation initiator; and
(iv) a thermoplastic resin, so as to provide a mixture,
and subjecting the mixture to melt processing or solvent-assisted solid-phase polymerisation.

20. The method of claim 19, wherein the vinyl monomer is present in the mixture in an amount between about 0.5% (w/w) and about 4% (w/w).

21. The method of claim 19 or claim 20, wherein the co-polymerisable anhydride is present in the mixture in an amount between about 0.5% (w/w) and about 4% (w/w).

22. The method of any one of claims 19 to 21, wherein the thermoplastic resin is present in the mixture in an amount between about 90 % (w/w) and about 98% (w/w).

23. The method of any one of claims 19 to 22, wherein melt processing comprises extrusion, molding, blown film, spinning, drawing, pressing, kneading, roll milling or thermoforming.

24. The method of claim 23, wherein melt processing comprises extrusion.

25. The method of any one of claims 19 to 24, wherein the modified thermoplastic resin composition is subjected to a surface treatment.

26. The method of claim 25, wherein the surface treatment is a treatment that imparts stain, oil and/or water repellent properties to the modified thermoplastic resin composition.

27. A modified thermoplastic resin composition, whenever prepared by the method of any one of claims 19 to 26.

28. A method for preparing a functional resin composition comprising combining the modified thermoplastic resin composition of claim 27 with one or more additives to form a mixture, and subjecting the mixture to melt processing.

29. The method of claim 28, wherein the one or more additives include a compound or compounds having antimicrobial, antiviral or antifouling properties.

30. The method of claim 29, wherein the compound or compounds having antimicrobial, antiviral or antifouling properties are hydrophilic compounds.

31. The method of claim 29, wherein the compound or compounds having antimicrobial, antiviral or antifouling properties are amphiphilic compounds.

32. The method of claim 31, wherein the amphiphilic compounds have a HLB value of greater than about 7.

33. The method of claim 31, wherein the amphiphilic compounds have a HLB value between about 7 and about 20.

34. The method of any one of claims 28 to 33, wherein the one or more additives include a core material resin.

35. The method of any one of claims 28 to 34, wherein the one or more additives include an antioxidant.

36. The method of any one of claims 28 to 35, wherein melt processing comprises extrusion, molding, blown film, spinning, drawing, pressing, kneading, roll milling or thermoforming.

37. The method of claim 36, wherein melt processing comprises extrusion.

38. A functional resin composition, whenever prepared by the method of any one of claims 28 to 37.

39. A method for producing a plastic article comprising shaping the functional resin composition of claim 38.

40. The method of claim 39, wherein shaping is achieved by molding.

41. The method of claim 40, wherein the molding is injection molding, rotational molding, blow molding or compression molding.

42. A method for preparing a plastic article comprising:
(i) combining:
(a) a modified thermoplastic resin composition;
(b) a core material resin; and
(c) a compound selected from: an alcohol ethoxylate, an alkylene oxide and a polyethylene glycol, to form a mixture;
(ii) subjecting the mixture to melt processing or solvent-assisted solid-phase polymerisation to provide a functional resin composition; and
(iii) shaping the functional resin composition to provide the plastic article,
and wherein the modified thermoplastic resin composition is prepared by mixing:
(d) a vinyl monomer;
(e) a co-polymerisable anhydride;
(f) a thermal free-radical polymerisation initiator; and
(g) a thermoplastic resin to form a mixture, and
(iv) subjecting the mixture to melt processing.

43. The method of claim 42, wherein the core material resin is polypropylene.

44. The method of claim 43, wherein the polypropylene is polypropylene random copolymer.

45. The method of any one of claims 42 to 44, wherein in (c), the compound is an alcohol ethoxylate.

46. The method of claim 45, wherein the alcohol ethoxylate has the following general formula: RO(CH₂CH₂O)ₙH, wherein R is C₁₂-C₁₄ alkyl and n=3 to 23.

47. The method of claim 46, wherein the alcohol ethoxylate has the following general formula: RO(CH₂CH₂O)ₙH, wherein R is C₁₂-C₁₄ alkyl and n = 3 to 9.

48. The method of any one of claims 45 to 47 wherein the alcohol ethoxylate has a HLB 10 value between about 10 and 11.

49. The method of any one of claims 42 to 48, wherein melt processing in steps (ii) and (iv) comprises extrusion.

50. The method of any one of claims 42 to 49, wherein the mixture in step (i) further comprises an antioxidant.

51. The method of any one of claims 42 to 50, wherein the vinyl monomer is styrene.

52. The method of any one of claims 42 to 51, wherein shaping in step (iii) is performed by molding.

53. The method of claim 52, wherein the molding is injection molding.

54. The method of any one of claims 42 to 53, wherein the plastic article is a protein-repellent plastic article.

55. A method for producing a plastic article comprising combining the modified thermoplastic resin composition of claim 27 with one or more additives to form a masterbatch, combining the masterbatch with a core material resin to form a mixture, and processing the mixture to form the plastic article.

56. A method for producing a plastic article comprising combining the modified thermoplastic resin composition of claim 27 with a masterbatch and a core material resin to form a mixture, and processing the mixture to form the plastic article.

57. The method of claim 55 or claim 56, wherein the masterbatch comprises a compound or compounds having antimicrobial, antiviral or antifouling properties.

58. The method of claim 57, wherein the compound or compounds having antimicrobial, antiviral or antifouling properties are hydrophilic compounds.

59. The method of claim 58, wherein the compound or compounds having antimicrobial, antiviral or antifouling properties are amphiphilic compounds.

60. The method of claim 59, wherein the amphiphilic compounds have a HLB value of greater than about 7.

61. The method of claim 60, wherein the amphiphilic compounds have a HLB value between about 7 and about 20.

62. A method for preparing a plastic article comprising:
(i) combining:
(a) a modified thermoplastic resin composition;
(b) a core material resin; and
(c) a masterbatch comprising an alcohol ethoxylate, an alkylene oxide or a polyethylene glycol, to form a mixture; and
(ii) shaping the mixture to provide the plastic article, wherein the modified thermoplastic resin composition is prepared by mixing:
(d) a vinyl monomer;
(e) a co-polymerisable anhydride;
(f) a thermal free-radical polymerisation initiator; and
(g) a thermoplastic resin to form a mixture, and
(iii) subjecting the mixture of (d), (e), (f) and (g) to melt processing or solvent-assisted solid-phase polymerisation.

63. The method of claim 62, wherein the core material resin is polypropylene.

64. The method of claim 63, wherein the polypropylene is polypropylene random copolymer.

65. The method of any one of claims 62 to 64, wherein the masterbatch comprises an alcohol ethoxylate.

66. The method of claim 65, wherein the alcohol ethoxylate has the following general formula: RO(CH₂CH₂O)ₙH, wherein R is C₁₂-C₁₄ alkyl and n = 3-9.

67. The method of claim 66, wherein the alcohol ethoxylate has the following general formula: RO(CH₂CH₂O)ₙH, wherein R is C₁₂-C₁₄ alkyl and n = 5.

68. The method of any one of claims 65 to 67, wherein the alcohol ethoxylate has a HLB value between 10 and 11.

69. The method of any one of claims 62 to 68, wherein shaping in step (ii) is performed by molding.

70. The method of claim 69, wherein the molding is injection molding.

71. The method of any one of claims 62 to 70, wherein melt processing in step (iii) comprises extrusion.

72. The method of any one of claims 62 to 71, wherein the vinyl monomer is styrene.

73. The method of any one of claims 62 to 72, wherein the mixture of (d), (e), (f) and (g) is free, or substantially free of surfactants.

74. A plastic article, whenever obtained by the method of any one of claims 42 to 73.
